(19) United States
(12) Patent Application Publication
(10) Pub. No.: US 2018/0009502 A1
(43) Pub. Date: Jan. 11, 2018

(54) SHOE AND PEDAL SYSTEM FOR BICYCLES

(71) Applicant: KLEIN DESIGNS LLC, Las Vegas, NV (US)

(72) Inventors: MAXWELL C. KLEIN, LAS VEGAS, NV (US); JOHN REDDING, LEXINGTON, KY (US)

(21) Appl. No.: 15/709,228

(22) Filed: Sep. 19, 2017

Related U.S. Application Data
(63) Continuation of application No. 14/686,652, filed on Apr. 14, 2015, now abandoned.

(51) Int. Cl. B62M 3/08; A43B 13/22; A43B 5/14

(52) U.S. Cl. CPC B62M 3/086; A43B 5/14; A43B 13/223

(57) ABSTRACT

A bicycle pedal system which allows riders to engage the sole of their shoe with the pedal to feel an operative engagement therebetween during normal riding conditions, while allowing the rider to easily detach the shoe from the pedal should the need arise. The system includes a shoe sole wearable on the foot of a user, wherein the shoe sole includes a lower surface and a plurality of first engagement elements extending from the lower surface. The system further comprises a bicycle pedal including a first surface, an opposing second surface, and a plurality of second engagement elements extending from the first surface and being complimentary to the first engagement elements. The shoe sole is configured to be selectively engageable with the pedal, with the first engagement elements being registered with the second engagement elements when the shoe sole is engaged with the pedal.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

### 1. Field of the Invention

The present invention relates generally to a pedaling system for a bicycle, and more specifically, to a bicycle pedal and a corresponding shoe configured to have cooperating engagement elements which allow a portion of the shoe to be selectively registered with the bicycle pedal when operating a bicycle to prevent slip-off of the shoe from the pedal.

### 2. Description of the Related Art

Bicycles are typically propelled by a rider, with the rider's feet being operatively engaged with respective pedals to transfer energy from the rider's legs to the bicycle. In particular, the pedals are operatively coupled to at least one of the wheels through an intervening gear and chain system for converting the pedaling motion of the rider's legs to rotation of the bicycle wheels. Accordingly, maintaining operative engagement between the pedal and the rider's foot is critical for propelling the bicycle.

Early bicycles included basic platform pedals, which typically include a surface upon which the rider may place his foot. Although platform pedals may be sufficient for leisurely bicycle riding, more aggressive styles of bicycle riding may result in one or more of the rider's feet inadvertently slipping off of the pedal. Such slippage may result in the rider losing control of the bicycle, or cause injury to the rider's leg if the rider attempts to re-engage with the pedal while the bicycle is moving. Accordingly, several advancements have been made in an attempt to prevent slippage of the rider's foot from the bicycle pedal.

One particular advancement includes a strap which is coupled to the pedal and is adapted to extend over the rider's shoe to secure the shoe to the pedal. The strap may be adjustable to allow the strap to be loosened for placing the shoe on the pedal, and tightened to maintain the shoe on the pedal. Although the strap aides in preventing the rider's shoe from slipping off the pedal, the strap also suffers from many deficiencies. In particular, the strap may require adjustment each time the rider uses the bicycle. Furthermore, the strap may prevent the rider from disengaging his foot from the pedal when riding the bicycle, such as when the rider comes to a stop and needs to balance on one foot. Another deficiency associated with the strap is that the strap may only be configured to engage with the rider's foot when the foot is placed on one side of the pedal.

Another advancement is pedal cage, which is coupled to the pedal and is adapted to extend around a front portion of the rider's shoe during operation of the bicycle. The pedal cage is adapted to allow the rider to “step into” the cage when the rider engages with the pedal, and easily “step out” of the cage to disengage from the pedal. However, the cage may only loosely retain the foot, and thus, slippage may still occur. Furthermore, the cage may be adapted for use on one side of the pedal, which may create difficulties in engaging with the cage when the bicycle is in motion, as the cage has a tendency to hang from the underside of the pedal.

Yet another advancement includes a “clip-in” pedal system, which includes a specifically configured pedal and a corresponding shoe having a cleat formed on the bottom of the shoe, wherein the cleat is releasably engageble with the pedal. The rider engages the shoe to the pedal by pressing onto the pedal with the shoe, which causes the cleat to become engaged with the pedal. When releasing the shoe from the pedal, the rider typically rotates the shoe, using the front end of the cleat as a pivoting point. As a result of the pivoting action, the cleat is released from the pedal, thereby allowing the shoe to be disengaged from the pedal.

The clip-in pedal system may suffer from certain disadvantages making use of such pedal system undesirable. For instance, the complexity associated with engaging and disengaging the shoe from the pedal may result in the clip-in pedal system being unfavorable when the rider repeatedly engages and releases the shoe from the pedal (e.g., to balance the bicycle, etc.). Furthermore, engagement between the shoe and pedal may be difficult if the shoe or pedal become clogged with dirt or mud. Another significant drawback associated with conventional clip-in pedal systems pertains to the shoes. In particular, shoes adapted for use in conventional clip-in pedal systems are specifically configured for primary use with the pedal. In other words, such clip-in pedal shoes are not intended for conventional shoe use. In this regard, it may be difficult or uncomfortable to walk in the shoes because of the hard, rigid cleat extending from the bottom of the shoe. Moreover, the cleat may damage soft surfaces, like hardwood floors

Accordingly, there is a need in the art for a pedal system which mitigates inadvertent slippage of the rider's shoe from the pedal, and includes a more comfortable shoe. Various aspects of the present disclosure address this particular need, as will be discussed in more detail below.

### BRIEF SUMMARY OF THE INVENTION

There is provided a hybrid bicycle pedal which combines certain characteristics of a conventional “clip-in” bicycle pedal and a standard flat pedal to attain benefits associated with each type of pedal. In particular, the pedal system allows riders to engage the sole of their shoe with the pedal to feel an operative engagement therebetween during normal riding conditions, while allowing the rider to easily detach the shoe from the pedal should the need arise. The shoe may also be configured to allow the user to comfortably and easily wear the shoe for other non-bicycle activities, such as walking and running. Thus, the pedal system allows a user to seamlessly transition between bicycling and walking/running.

According to one embodiment, there is provided a system for transmitting power between a user and a bicycle. The system includes a shoe sole wearable on the foot of a user, wherein the shoe sole includes a lower surface and a plurality of first engagement elements extending from the lower surface. The system further comprises a pedal for use on a bicycle, wherein the pedal includes a first surface, an opposing second surface, and a plurality of second engagement elements extending from the first surface and being complimentary to the first engagement elements. The shoe sole is configured to be selectively engageable with the pedal, with the first engagement elements being registered with the second engagement elements when the shoe sole is engaged with the pedal.

The sole may include an upper surface opposite the lower surface, with the first engagement elements extending from the lower surface and away from the upper surface. Each first engagement element may be of a hexagonal shape. The plurality of first engagement elements may be arranged in a honeycomb pattern. Each first engagement element may extend away from the lower surface and terminate at a distal surface. Each first engagement element may include a side surface extending between the distal surface and the lower surface, wherein the side surface extends at non-perpendicular angle to the distal surface.

Each second engagement element of the pedal may be of a hexagonal shape. The plurality of second engagement elements on the pedal may be arranged in a honeycomb pattern. The second engagement elements may extend from the first surface toward the second surface of the pedal. Each second engagement element of the pedal may define a recess adapted to receive a respective one of the plurality of first engagement elements. Each second engagement element of the pedal may define an opening extending completely between the first surface and the second surface of the pedal. Each second engagement element of the pedal may include a side surface extending from the first surface of the pedal at a non-perpendicular angle to the first surface.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a lower perspective view of a bicycle pedal and a shoe in accordance with an embodiment of the present disclosure;

FIG. 2 is an upper perspective view of the bicycle pedal of FIG. 1 shown rotatably coupled to a bicycle frame in accordance with an embodiment of the present disclosure;

FIG. 3 is an upper perspective view of the bicycle pedal of FIG. 1 in accordance with an embodiment of the present disclosure;

FIG. 4 is an end view of the bicycle pedal of FIG. 1 in accordance with an embodiment of the present disclosure;

FIG. 5 is a top view of the bicycle pedal;

FIG. 6 is a top view of a second embodiment of a bicycle pedal;

FIG. 7 is a cross-sectional view of the bicycle pedal taken along section lines 7-7 of FIG. 6;

FIG. 7A is a cross sectional view of a bicycle pedal having inner and outer surfaces shaped in outwardly protruding convex configurations;

FIG. 8 is a bottom view of a shoe sole of the shoe shown in FIG. 1;

FIG. 9 is a cross-sectional view of the shoe sole taken along section lines 9-9 of FIG. 8; and

FIG. 10 is a cross-sectional view a shoe sole registered with a pedal in accordance with an embodiment of the present disclosure.

Common reference numerals are used throughout the drawings and the detailed description to indicate the same elements.

### DETAILED DESCRIPTION OF THE INVENTION

The detailed description set forth below in connection with the appended drawings is intended as a description of certain embodiments of a bicycle pedal system and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Various aspects of the present disclosure are directed toward a system 10 including a uniquely configured bicycle pedal 12 and a shoe 14 having a sole 16 that is complimentary to the bicycle pedal 12. More specifically, the sole 16 and bicycle pedal 12 include corresponding cells or engagement elements (e.g., projections and complimentary openings) adapted to be selectively engageable with each other to provide grip between the pedal 12 and the sole 16 when riding a bicycle. The engagement elements are further configured to allow the rider to quickly and easily remove the sole 16 from the pedal 12 on-the-fly, should the need arise, such as when the rider comes to a stop and needs to balance the bicycle on one leg. Furthermore, the configuration of the engagement elements on the sole 16 of the shoe 14 allows the shoe 14 to be used in a conventional fashion, such as use in normal walking or running. In this regard, the system 10 does not require dedicated shoes intended solely for bicycling.

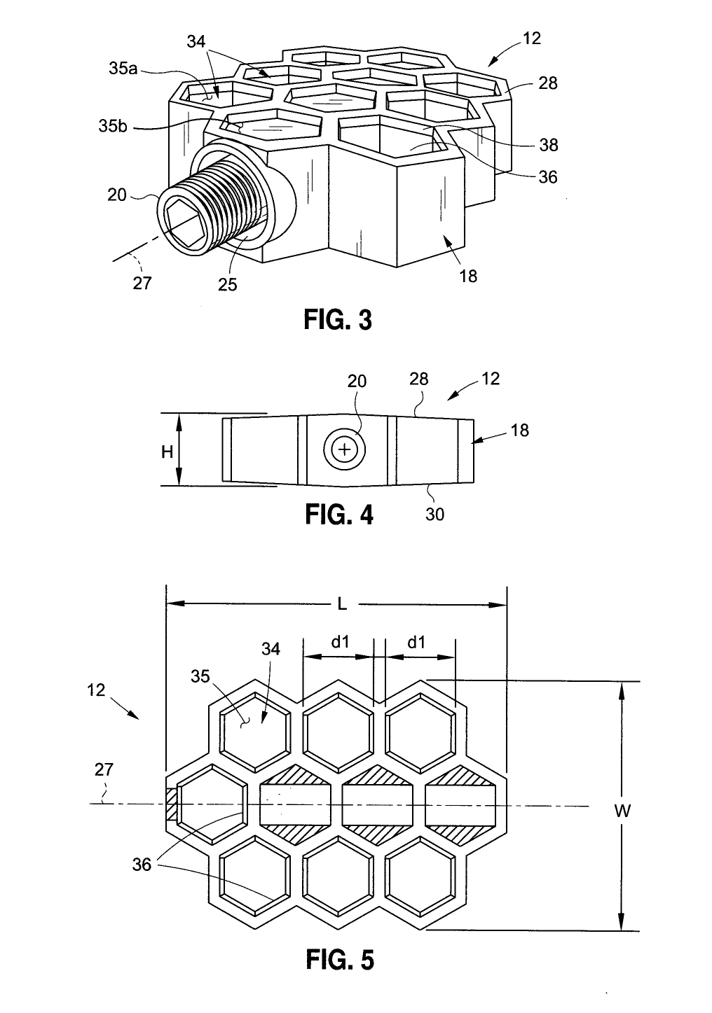

According to one embodiment, the bicycle pedal 12 includes a pedal body 18 rotatably coupled to a bicycle crank arm 22. The pedal body 18 includes a pedal opening 25 disposed about a pedal rotation axis 27 (see FIG. 3). A spindle 20 (see FIG. 3) is coupled to the pedal body 18 and is adapted to couple the pedal body 18 to the crank arm 22. The spindle 20 may by coupled to the pedal body 18 via a journal bearing which enables rotatable coupling of the pedal 12 to the bicycle crank arm 22. Furthermore, the spindle 20 may include an externally threaded end portion which is engageable with a corresponding internally threaded opening (not shown) formed on the crank arm 22. It is understood that a conventional bicycle includes a pair of crank arms 22 which are coupled to a bicycle crank hub 24, which defines a crank hub axis 26. The crank arms 22 typically extend from the crank hub 24 in substantially opposing directions along an axis that is substantially perpendicular to the crank hub axis 26. Each crank arm 22 includes a pedal 12 coupled to a distal end portion thereof to allow the rider's feet to operatively engage with the pedal 12. The pedal 12 shown in FIG. 2 is a left-side pedal 12, although it is understood that the right-side pedal 12 may be similar to the left-side pedal 12.

The pedal body 18 includes a first surface 28, an opposing second surface 30, and an outer side surface 32 extending around the periphery of the pedal body 18 between the first and second surfaces 28, 30 thereof. The first and second surfaces 28, 30 may be formed without rough or jagged features commonly included in standard flat pedals for purposes of enhancing traction. Such features may not be necessary in the pedal 12 due to the unique and cooperative configuration between the pedal 12 and the shoe 14. As such, the unique configuration of the first and second surfaces 28, 30 may reduce the risk of cutting the rider's shin on the pedal 12.

The pedal body 18 further includes a plurality of cells or pedal engagement elements 34 specifically configured and adapted for engagement with the sole 16 of the rider's shoe 14, as will be described in more detail below. In the exemplary embodiment, the pedal engagement elements 34 include a plurality of recesses or openings 35 formed in the pedal body 18, wherein certain openings 35a extend completely from the first surface 28 to the second surface 30, while other openings 35b extend only partially through the pedal body 18 due to interference with the spindle 20. Along these lines, the spindle 20 may be exposed in the openings 35, or alternatively, the pedal body 18 may include a web or other structure which extends from the spindle 20, and in some embodiments, may encapsulate the spindle 20. By extending completely between the first and second surfaces 28, 30, the openings 35a allow both the first and second surfaces 28, 30 to engage with the shoe 14. Other embodiments may include openings or recesses 35 which extend only partially through the pedal body 18. For instance, the pedal 12 may include a first set of recesses which extend into the pedal body 18 from the first surface 28 and extend only partially through the pedal body 18 toward the second surface 30, and/or a second set of recesses which extend into the pedal body 18 from the second surface 30 and extend only partially through the pedal body 18 toward the first surface 28. In this respect, it is contemplated that by forming recesses or openings adjacent both the first and second surfaces 28, 30, the pedal 12 may be engaged by the rider's foot on both surfaces 28, 30.

The pedal body 18 additionally includes a plurality of inner surfaces 36 extending between the first surface 28 and the second surface 30 and disposed about respective axes to define the pedal openings 35. The exemplary openings 35 are hexagonal in shape, and thus, each inner surface 36 includes three pairs of opposed faces. The openings 35 are spaced from each other and are arranged in a “honeycomb” pattern. Although the exemplary embodiment includes openings 35 which are hexagonal in shape, it is understood that the shape of the opening 35 may be varied in other embodiments. Along these lines, other pedals 12 may include openings 35 which are triangular, square, oval, circular, etc. Furthermore, the exemplary embodiment depicted in the Figures includes a pedal body 18 having ten openings 35 formed therein, wherein the ten openings are arranged in three “rows,” with a first row including three openings 35, a second row including four openings 35, and a third row including three openings 35 (e.g., a “3-4-3” arrangement). Those skilled in the art will readily appreciate that the number of openings 35 is exemplary in nature only, and does not limit the scope of the invention. Along these lines, in other embodiments, the pedal body 18 may have greater than ten openings 35 or less than ten openings 35. For instance, some riders may prefer a small pedal 12 with minimal openings 35 to reduce the overall weight of the pedal 12 and to mitigate pedal strikes on the ground when navigating the bicycle through tight spaces or while turning around a protruding obstacle or marker. Thus, one particular embodiment may be formed with only seven openings 35 arranged in a 2-3-2 arrangement.

Referring to FIG. 5, an opposed pair of faces may be spaced apart by a distance, dl, which according to one embodiment is approximately ⅞″, although the distance dl may be varied without departing from the spirit and scope of the present invention. The pedal body 18 further defines a length, L, along the pedal rotation axis 27, and a width, W, generally perpendicular to the pedal rotation axis 27. According to one embodiment, the length L is approximately equal to 4″ and the width W is approximately equal to 3″, although the size of the length L and the width W may be varied in other embodiments. Furthermore, the pedal body 18 may be of a maximum height, H, defined by the first and second surfaces 28, 30 and equal to approximately 1″. Along these lines, it is understand that the first and second surfaces 28, 30 may have a slight crown or taper from the middle of the pedal body 18, wherein the height may decrease away from the middle of the pedal body 18.

According to one embodiment, the inner surface 36 may be particularly configured to quickly and easily engage with the sole 16 of the shoe 14. Along these lines, the inner surface 36 may include angled or include offset end portions 38 adjacent the first and second surfaces 28, 30, wherein the offset end portion is non-perpendicular to the first and second surfaces 28, 30. The angled portions 38 may define a slightly larger opening relative to the remaining portion of the inner surface 36. Thus, the larger opening makes it easier for a rider to register the sole 16 in the openings 35. The outer surface 32 may also be angled and defined a convex configuration (see FIG. 7A and surface 132). The convex inner and outer surfaces may create a more secure fit with the rider's shoe, as a portion of the pedal body 18 is advanced into a corresponding groove formed in the rider's shoe, as will be described in more detail below.

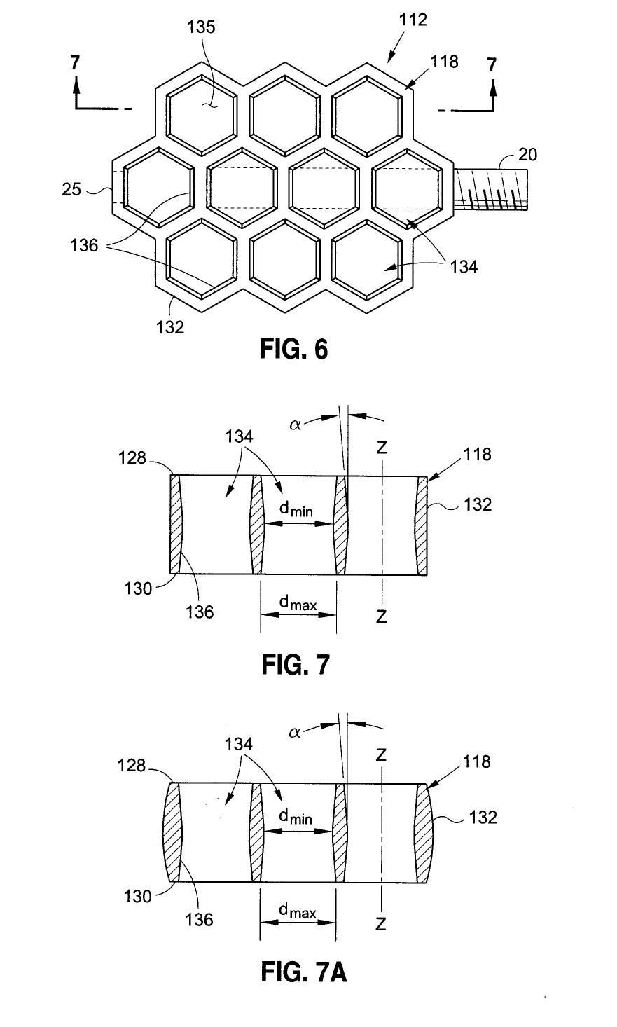

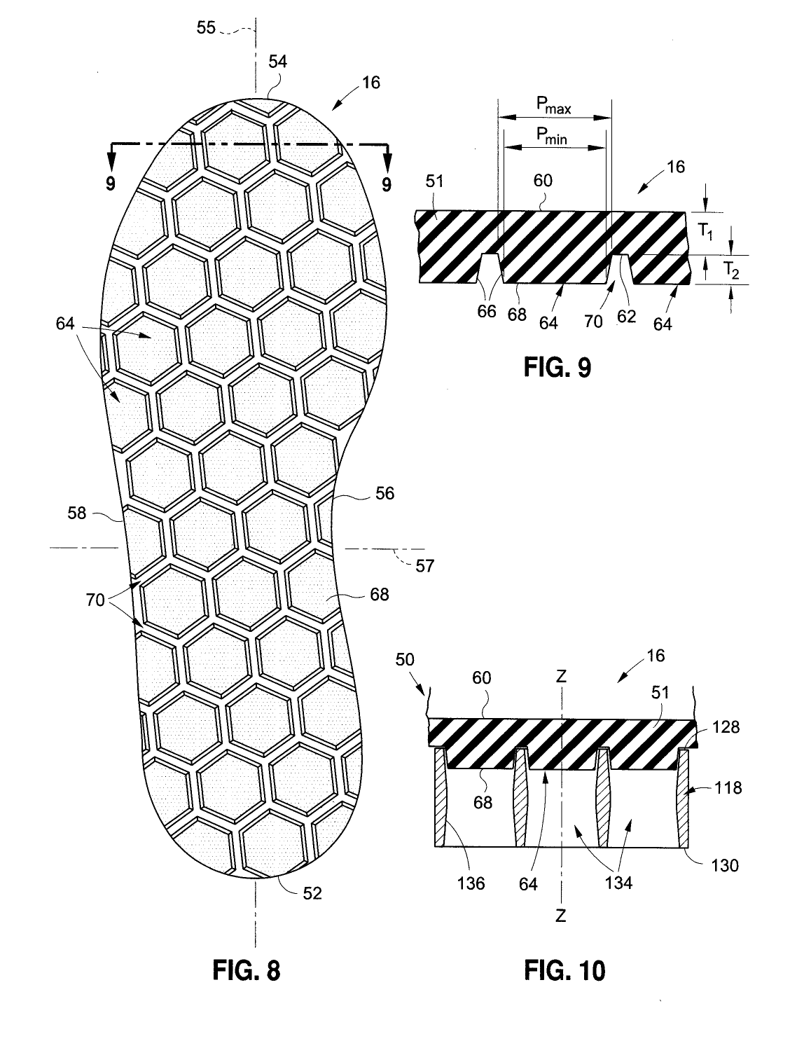

Referring now to FIGS. 6 and 7, there is depicted a second embodiment of a pedal 112 having a pedal body 118 including a first surface 128, an opposing second surface 130, and outer side surface 132, a plurality of engagement elements 134 including openings 135, and a plurality of inner surfaces 136. The primary distinction between the second embodiment of the pedal 112 and the first embodiment of the pedal 112 lies in the angle of the inner surface 136. In particular, the inner surface 136 for each engagement element 134 is disposed about an axis Z-Z and is non-parallel to the axis Z-Z. In particular, opposed faces of the inner surface 136 define a minimum distance, dₘᵢₙ, at an approximate midpoint between the first and second surfaces 128, 130, and a maximum distance, dₘₐₓ, at the approximate intersection between the inner surface 136 and the first and second surfaces 128, 130. The variability in the inner surface 136 produces a taper angle, a, and results in an opening 135 that is wider at the first and second surfaces 128, 130 to facilitate engagement with the sole 16.

The pedal body 18 may be formed of any material having sufficient rigidity to withstand repeated impact with the sole 16 of the shoe 14. Exemplary materials for the pedal body 18 include, but are not limited to nylon reinforced composites, steel, aluminum alloys, other metals or alloys, carbon and glass-fiber composite materials, or other composite materials known in the art.

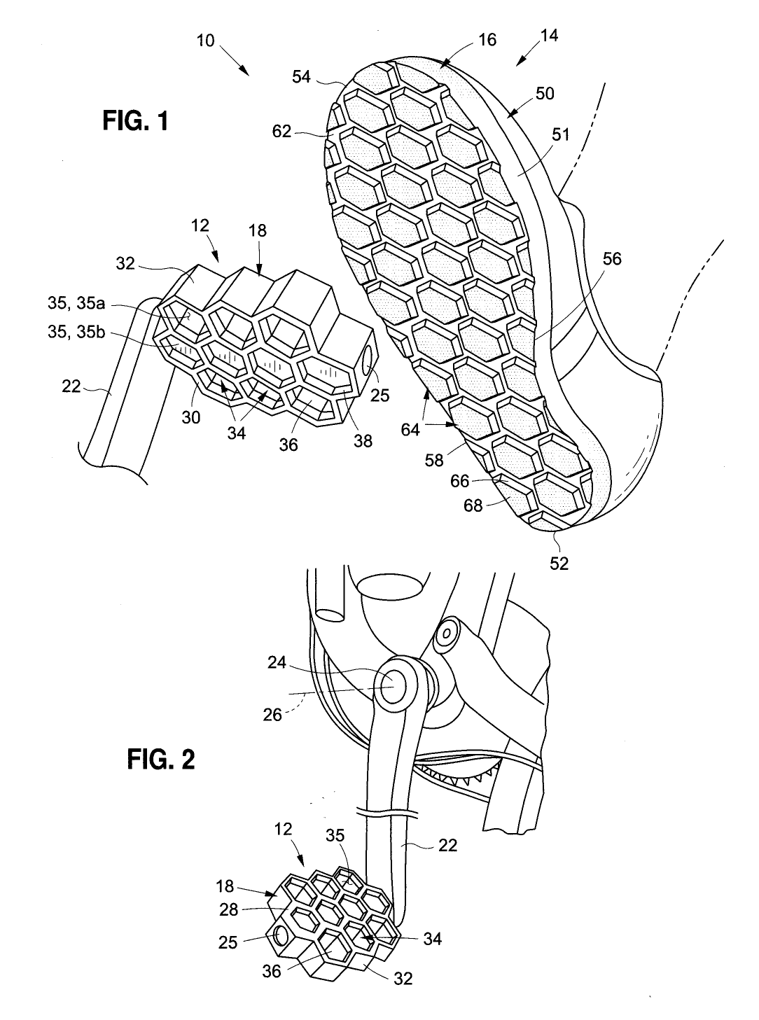

Referring back to FIG. 1, the shoe 14 includes a sole 16 coupled to a main body 50, which is adapted to receive a rider's foot. The main body 50 may include an opening through which the rider advances his foot when donning the shoe 14 on the foot. The main body 50 may be secured to the foot with laces, hook-and-loop fastening material, buckles, straps, etc. In this regard, the shoe 14 may be fashioned similar to a conventional athletic shoe (e.g., sneaker), boot, sandal, dress shoe, or other footwear known in the art.

The sole 16 includes a main body 51 including heel portion 52, a toe portion 54 opposite the heel portion 52, a medial side portion 56 and a lateral side portion 58 opposite the medial side portion 56. The main body 51 defines a longitudinal axis 55 extending from the heel portion 52 to the toe portion 54, and a latitudinal axis 57 extending from the medial side portion 56 to the lateral side portion 58. The sole 16 includes an upper surface 60, which faces the main body 50 of the shoe 14, and an opposing lower surface 62 which faces away from the main body 50. The upper and lower surfaces 60, 62 define a main body thickness, T₁, therebetween. The main body thickness T₁ may be uniform along the sole 16, or may vary in a longitudinal direction (i.e., between the heel portion 52 to the toe portion 54) and/or in a latitudinal direction (i.e., between the medial side portion 56 and the lateral side portion 58). For instance, it may be desirable to have a greater main body thickness T₁ under the heel portion 52, which may be subjected to greater impact when the shoe 14 is used for walking.

The sole 16 further includes a plurality of sole engagement elements 64 extending from the lower surface 62, wherein the plurality of sole engagement elements 64 are specifically configured and adapted to register with the plurality of pedal engagement elements 34 for creating an operative engagement between the sole 16 and the pedal 12. In the exemplary embodiment, the sole engagement elements 64 are hexagonal projections extending from the lower surface 62 and away from the upper surface 60. Each projection includes a projection side surface 66 and a terminal end surface 68, with the projection side surface 66 circumnavigating the terminal end surface 68. The projection 64 defines a projection thickness, T₂, as the distance between the terminal end surface 68 and the lower surface 62 of the main body 51. According to one embodiment, the projection thickness T₂ is substantially equal to ¼″, although the thickness T₂ may be greater than ¼″ or less than ¼″ without departing from the spirit and scope of the present invention.

The hexagonal projections 64 are specifically configured and adapted to be similar in size to the openings 35 formed in the pedal 12. In particular, the hexagonal projections 64 define a slightly smaller peripheral dimension, which allows the projections 64 to be received within a respective one of the openings 35. Along these lines, the projection side surface 66 is tapered or disposed in a non-perpendicular orientation relative to the lower surface 62 such that the distance between opposing side faces of the projection side surface 66 define a maximum distance, Pₘₐₓ, adjacent the lower surface 62 and a minimum distance, Pₘᵢₙ, at the terminal end surface 68, wherein Pₘₐₓ is greater than Pₘᵢₙ. The magnitude of Pₘₐₓ is smaller than the magnitude of dₘₐₓ defined by the inner surface 36, 136 of the pedal 12 so as to allow the projections 64 to be received within the openings 35.

The projections 64 are spaced from each other to define a network of grooves 70 between adjacent projections 64. The configuration of the grooves 70 correspond to the configuration of the pedal body 18 so as to allow the pedal body 18 to be at least partially received within the grooves 70 when the sole 16 is engaged with the pedal 12. In the exemplary embodiment, the projections 64 and grooves 70 are arranged in a honeycomb pattern complimentary to the honeycomb pattern of the pedal openings 35.

The sole 16 is preferably formed from a durable, resilient material, such as rubber or other similar materials known in the art. According to one embodiment, the main body 51 of the sole 16 and the projections 64 exhibit similar structural characteristics, such as density or hardness. On the other hand, it is contemplated that the main body 51 may exhibit structural characteristics which differ from the projections 64. For instance, in one embodiment, both the main body 51 and the projections 64 are formed of rubber, although the main body 51 may be of a rubber density substantially equal to 0.95, while the projections 64 may be of a rubber density substantially equal to 0.25. In other embodiments, the main body 51 may be of a rubber density that is less than the rubber density of the projections 64. Of course, those skilled in the art will recognize that the main body 51 and projections 64 may be formed of other non-rubber materials, and the density or hardness of those materials may vary without departing from the spirit and scope of the present invention.

With the basic structural features of the pedal 12 and shoe 14 described above, the following discussion will focus on an exemplary use of the system 10. Before riding the bicycle, the rider places shoes 14 on each one of the rider's feet, and with the shoes 14 secured to the rider's feet, the rider mounts the bicycle and aligns the shoes 14 over respective pedals 12. The shoes 14 are generally aligned with pedal 12 with the longitudinal axis 57 of the sole 16 disposed in generally perpendicular relation to the pedal rotation axis 27. It is understood that the longitudinal axis 57 need not be exactly perpendicular to the pedal rotation axis 27. With the shoes 14 generally aligned over the pedals 12, the rider presses the shoes 14 against the pedals 12 to advance the sole projections 64 into the pedal openings 35. The tapered configuration of the pedal inner surface 36, 136 and/or the outer surface 32, 132, and the projection side surface 66 allows the projections 64 to self-align or self-register with the pedal openings 35. Such self-alignment or self-registering results in individual projections 64 on the sole 16 becoming coaxially aligned with individual openings 35 on the pedal 12. Since the sole 16 is preferably configured with projections 64 formed on substantially the entire lower surface 62 thereof, the sole 16 may engage with the pedal 12 in several different positions. Such positional adjustability differs from conventional clip-in pedal systems, wherein the rider's shoe can only clip-in to the pedal in a single position. In particular, the rider using the pedal system 10 may selectively position the sole 16 relative to the pedal 14 and move the sole 16 relative to the pedal 12 one cell or projection 64 at a time. In this respect, the rider may move the sole 16 to position the pedal 12 closer to the heel portion 52 or the toe portion 54. Furthermore, the rider may move the sole 16 relative to the pedal 12 along the pedal rotation axis 27 so as to selectively position the sole 16 relative to the crank arm 22. The unique configuration of the sole 16 and the pedal 12 further allows a user to adjust the position of the sole 16 relative to the pedal 12 on-the-fly or while riding the bicycle.

The engagement between the sole 16 and pedal 12 allows the rider to more easily transfer energy from the rider's foot to the bicycle pedal 12. In this respect, the unique configuration of the sole 16 and pedal 12 creates a secure feel for the rider which is similar to a conventional clip-in pedal system. However, should the need arise for the rider to remove his foot from the pedal 12, the rider can easily disengage the sole 16 from the pedal 12 by simply lifting the foot from the pedal 12, similar to the process of lifting one's foot from a standard flat pedal. Thus, the pedal system 10 is a hybrid system incorporating the benefits of conventional clip-in pedal systems and standard flat pedal systems, without suffering from the disadvantages commonly associated with such systems.

When the rider is done riding the bicycle, the rider steps off the bicycle. The shoes 14 may remain on the rider's feet for use as conventional shoes, since the sole 16 is configured to support other non-bicycle activities, e.g., walking, running, etc. In this respect, the pedal system 10 does not require dedicated, bicycle-only shoes similar to conventional clip-in systems. Therefore, individuals who ride bicycles for everyday commuting can employ the pedal system 10 and use the shoes 14 throughout the day, without requiring separate bicycle shoes, and non-bicycle shoes.

While the foregoing description and Figures show the pedal 12 as including openings 35 and the sole 16 as including corresponding projections 64 adapted to engage with the openings 35, it is understood that the configuration may be reversed in other embodiments. In particular, the pedal 12 may include projections which are inserted in openings, recesses or voids formed in the sole 16 of the shoe 14.

Furthermore, it is understood that the pedal 12 may be used on any type of bicycle, including BMX bikes, mountain bikes, road bikes, beach cruisers, kid's bikes, women's bikes, men's bikes, etc. It is further contemplated that the pedal 12 described herein may be installed on a bicycle during the original assembly of bicycle, or alternatively, the pedal 12 may be specifically adapted for retrofit onto an existing bicycle.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A system for transmitting power between a user and a bicycle, the system comprising:
a shoe sole wearable on the foot of a user, the shoe sole having a lower surface and a plurality of first engagement elements extending from the lower surface; and
a pedal for use on a bicycle, the pedal having a first surface, an opposing second surface, and a plurality of second engagement elements extending from the first surface and being complimentary to the first engagement elements;
the shoe sole being configured to be selectively engageable with the pedal, the first engagement elements being registered with the second engagement elements when the shoe sole is engaged with the pedal.

2. The system recited in claim 1, wherein the sole includes an upper surface opposite the lower surface, the first engagement elements extending from the lower surface and away from the upper surface.

3. The system recited in claim 1, wherein each first engagement element is of a hexagonal shape.

4. The system recited in claim 3, wherein the plurality of first engagement elements are arranged in a honeycomb pattern.

5. The system recited in claim 1, wherein each second engagement element is of a hexagonal shape.

6. The system recited in claim 1, wherein the second engagement elements extend from the first surface toward the second surface.

7. The system recited in claim 6, wherein each second engagement element defines a cavity adapted to receive a respective one of the plurality of first engagement elements.

8. The system recited in claim 6, wherein each second engagement element defines an opening extending completely between the first surface and the second surface.

9. The system recited in claim 1, wherein each first engagement element extends away from the lower surface and terminates at a distal surface, each first engagement element having and an inner surface extending between the distal surface and the lower surface, the inner surface having at least a portion extending at non-perpendicular angle to the distal surface.

10. The system recited in claim 1, wherein each second engagement element includes a side surface extending from the first surface at a non-perpendicular angle to the first surface.

11. A shoe sole adapted for use with a bicycle pedal having a plurality of pedal engagement elements, the shoe sole comprising:
a main body having a lower surface; and
a plurality of sole engagement elements extending from the lower surface and being complimentary to the pedal engagement elements;
the shoe sole being configured to be selectively engageable with the pedal, the sole engagement elements being registered with the pedal engagement elements when the shoe sole is engaged with the pedal.

12. The shoe sole in claim 11, wherein the body includes an upper surface opposite the lower surface, the sole engagement elements extending from the lower surface and away from the upper surface.

13. The shoe sole recited in claim 11, wherein each sole engagement element is of a hexagonal shape.

14. The shoe sole recited in claim 13, wherein the plurality of sole engagement elements are arranged in a honeycomb pattern.

15. The shoe sole recited in claim 11, wherein each sole engagement element extends away from the lower surface and terminates at a distal surface, each sole engagement element having and a first side surface extending between the distal surface and the lower surface, the first side surface extending at non-perpendicular angle to the distal surface.

16. A bicycle pedal for use with a shoe sole having a plurality of sole engagement elements, the bicycle pedal comprising:
a pedal body having a first surface, an opposing second surface, and plurality of pedal engagement elements extending from the first surface and being complimentary to the shoe engagement elements;
the pedal being configured to be selectively engageable with the shoe sole, the pedal engagement elements being registered with the shoe engagement elements when the pedal is engaged with the shoe sole.

17. The bicycle pedal recited in claim 16, wherein the pedal engagement elements extend from the first surface toward the second surface.

18. The bicycle pedal recited in claim 17, wherein each pedal engagement element defines a cavity adapted to receive a respective one of the plurality of sole engagement elements.

19. The bicycle pedal recited in claim 16, wherein each pedal engagement element defines an opening extending completely between the first surface and the second surface.

20. The bicycle pedal recited in claim 16, wherein each pedal engagement element includes a side surface extending from the first surface at a non-perpendicular angle to the first surface.
